(19) United States
(12) Patent Application Publication
(10) Pub. No.: US 2009/0258128 A1
(43) Pub. Date: Oct. 15, 2009

(54) Hydrogenated oil flavor-imparting agent

(76) Inventors: Tsukasa Saito, Yokosuka-shi (JP); Toshinobu Suzuki, Kawasaki-shi (JP); Kenji Haraguchi, Tokyo (JP); Junichi Tamura, Izumisano-shi (JP); Atsushi Nago, Izumisano-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/310,980

(22) PCT Filed: Sep. 11, 2007
(86) PCT No.: PCT/JP2007/068023

§ 371 Date: Mar. 13, 2009

(30) Foreign Application Priority Data
Sep. 14, 2006 (JP) 2006-249791

(51) Int. Cl. A23D 9/007; A21D 13/08

(52) U.S. Cl. 426/538

(57) ABSTRACT

This invention discloses a hydrogenated oil flavor-imparting agent comprising vanillin and/or ethyl vanillin, and hydrogenated-oil-flavored oil and fat formed by use of the agent.

### TECHNICAL FIELD

This invention relates to a hydrogenated oil flavor-imparting agent and oils and fats having hydrogenated oil flavor which are prepared with use of the agent.

### BACKGROUND ART

Hydrogenated oil refers to edible processed oils and fats which are solid at ambient temperature and are manufactured usually by such a method as hydrogenating starting vegetable oils and fats such as soybean oil, rapeseed oil, palm oil, coconut oil, palm kernel oil and the like or animal oils and fats such as whale oil, fish oil, beef tallow, lard and the like, at temperatures of about 160-about 180° C., in the presence of nickel catalyst. Hydrogenated oil is used in large quantities in broad application range, as it can be made of cheap oils and fats materials and has stable quality. In particular, making use of high melting point characterizing it, hydrogenated oil is widely utilized for melting point control of oils and fats, impartment of, or improvement in, crunchy texture to food and giving crisp state to fried food when it is used as frying oil. Oils and fats in certain occasions are used for food production making use of their own flavors, like sesame oil, soybean oil, rapeseed oil, lard and the like, but depending on the kind of foodstuff, such original flavors could be objectionable. Hydrogenated oil is taken as being free of offensive taste and smell of starting vegetable or animal oils and fats and has light, pleasant flavor and relish and hence is used for oils and fats foodstuff such as margarine, shortening and butter cream; sweet stuff such as doughnuts, cakes and chocolate; and frying oil of still other food. Recently the crunchiness and fresh-from-the-fryer crisp state of the foods which are fried in hydrogenated oil contribute to improve quality of foodstuff for microwave oven cooking.

As a defect of hydrogenated oil, it normally has an offensive smell which is called “hydrogenation odor”, “back odor of hydrogenation”, “back odor” or “hydrogenated oil odor” (which is hereafter called “hydrogenated oil odor”). The odor sometimes impairs flavor of the foodstuff during or after their production and causes a problem. The cause of the odor is aldehydes and ketones including 6-nonenal, which are held to be produced by the fatty acids present in oils and fats, under the influence of light, heat and the like (cf. “Components of Edible Oils and fats Odors”, Oil Chemistry, 17(1), 2-18 (1968); “On Components of Oils and fats Odors (Second Report), Inspection of Hydrogenation Odor”, Oil Chemistry, 19(9), 883-887 (1970).

In contrast with the above, the term, “hydrogenated oil odor”, is used among actual users or developers occasionally to express the flavor of foodstuff made with use of hydrogenated oil. In such a case, the term is used to express the flavor positively contributing to the quality of the product. (The flavor is hereafter referred to as “hydrogenated oil flavor”.) Specifically, “hydrogenated oil flavor” refers to the rich, delicate sweetness which is created in consequence of food processing such as heating given to hydrogenated oil-containing foodstuff. For instance, where a hydrogenated oil is used as frying oil of doughnuts, such effects are produced to impart nice and sweet cooked finish to the fried doughnuts, provoking consumers' desire to buy and giving full satisfaction during eating. This “hydrogenated oil flavor” produces an important value of the products themselves, and no substitute oil or fat other than the hydrogenated oil, which imparts flavor or relish comparable to “hydrogenated oil flavor”, has been developed. While it has been commonly practiced to add spice, flavor and the like to doughnuts for flavoring, the flavors of added spice or flavor is too strong, which impairs the original food's own relish and above “hydrogenated oil flavor” cannot be obtained even when the adding amount of the additives is adjusted.

As a hydrogenated oil whose hydrogenated oil odor is improved, there is the extremely hydrogenated oil whose double bonds are hydrogenated to the limit at the time of hydrogenated oil production. This, however, is not completely freed of hydrogenated oil odor. Addition of spice or flavor to hydrogenated oil to improve the latter's flavor also has been practiced. No additive, however, which is added to hydrogenated oil and can impart “hydrogenated oil flavor” to the food processed with the hydrogenated oil containing the additive is known. Furthermore, proposals heretofore made include frying oils and fats free of oil bleeding and hydrogenated oil odor, which is formed by adding liquid vegetable oil, extremely hydrogenated oil and polyglycerin fatty acid ester to palm oil (cf. JP Hei 9 (1997)-322708A), frying oils and fats compositions having anti-oxidation effect and reduced hydrogenated oil odor, which contain oils and fats having a melting point not lower than 25° C., as formed through an ester interchange between palm-originated oils and fats and extremely hydrogenated high erucin rapeseed oil (cf. JP Hei 11 (1999)-155483A); spraying oils and fats compositions having anti-oxidation effect and reduced hydrogenated oil odor, which contain oils and fats having a melting point not lower than 25° C., as formed through an ester interchange between palm-originated fat and oil and extremely hydrogenated high erucin rapeseed oil (cf. JP Hei 11 (1999)-262358A); frying oils and fats whose flavor deterioration and generation of hydrogenation odor are suppressed by mixing ester interchange oils and fats with oils and fats to make the number of double bond in the constituent fatty acids at least 2 (cf. JP 2000-270770A); flavor-added edible oils and fats having very little back odor of hydrogenation, formed by converting flavor-added edible hydrogenated oil into fine particles (cf. JP Hei 6 (1994)-327403A); savored oil imparted with relish and good body and having reduced hydrogenated oil odor, which contains powdered dairy product and oil-soluble component derived from heating reaction of reduced sugar (cf. JP Hei 7 (1995)-46961A); coating spice powder by which flavor improvement of food accompanied by heating is brought about by emulsifying flavor in the presence of a compound having gel-forming ability and spray-drying the same (cf. JP Patent No. 2811242); and a method of frying Chinese noodles in vegetable hydrogenated oil, in which reduced sugar or amino acid is added at the time of frying to transfer the aldehyde-derived odor of the hydrogenated oil to the noodles (cf. JP 2002-536972A).

These proposals, however, aim at improving the back odor of hydrogenation characteristic in hydrogenated oil, which odor is generated during use of the hydrogenated oil, or maintaining flavor of fried noodles. Those references cited above contain no description or suggestion about impartment or enhancement of “hydrogenated oil flavor” meaning the glutinous, delicate sweetness produced in consequence of food processing such as heating, let alone the presence per se of these flavors. Also as a consequence of the announcement by the Federal Government of U.S.A. on the guideline for indication of trans fatty acid content in foodstuff in view of the liability for the acid to induce arteriosclerosis, concerned makers are increasingly reluctant to use hydrogenated oil which contains much trans fatty acid and an effective solution such as development of oils and fats substitute is in strong demand.

### DISCLOSURE OF THE INVENTION

The object of the present invention is to offer a hydrogenated oil flavor-imparting agent which can impart glutinous, delicate sweetness to food, when it is added to oils and fats and used as frying oil for heat-cooking food, or is added directly to food to be heat-cooked; and to offer the hydrogenated-oil-flavored oils and fats prepared with the agent.

We have engaged in concentrative studies with the view to accomplish the above object, to now discover that addition of vanillin or ethyl vanillin to liquid oils and fats at a specific concentration, surprisingly, can impart the “hydrogenated oil flavor” to the oils and fats, and also can impart to the food cooked therewith the high quality flavor and relish which is referred to as “hydrogenated oil flavor”. This invention is whereupon completed.

Thus, the present invention offers an agent for imparting hydrogenated oil flavor, which is characterized by comprising at least one component selected from vanillin and ethyl vanillin as an active ingredient.

The invention furthermore offers hydrogenated-oil-flavored oils and fats characterized by comprising at least one component selected from vanillin and ethyl vanillin at a concentration within a range of 1-10,000 ppm.

According to the present invention, high quality flavor and relish which is referred to as “hydrogenated oil flavor” can be imparted to food, by adding the hydrogenated oil flavor-imparting agent to oils and fats and heat-cooking the food using the fats and oils as frying oil; or by adding the agent directly to food and heat processing the food.

Hereinafter the hydrogenated oil flavor-imparting agent and the hydrogenated-oil-flavored oils and fats according to the present invention are explained in further details.

The vanillin and/or ethyl vanillin used in the hydrogenated oil flavor-imparting agent of the invention may be any of those extracted from natural sources or those synthesized. As commercial vanillin, for example, Rhovanil (tradename, Rhodia Inc.) and EuroVanillin Supreme (tradename, Borregaard Ingredients Co.) can be named, and as commercial ethyl vanillin, for example, Rhodiarome Extra-Pure (tradename, Rhodia Inc.) and Euro Vanillin Aromatic (Borregaard Ingredients Co.) can be named, while not limited thereto.

The hydrogenated oil flavor-imparting agent of the present invention can contain such vanillin and/or ethyl vanillin at a concentration based on the weight of the agent, generally within a range of 0.1-95 wt %, preferably 0.5-50 wt %, inter alia, 5-20 wt %. It may also consist of substantially above vanillin and/or ethyl vanillin only.

Where necessary, the hydrogenated oil flavor-imparting agent of the invention can contain flavoring compound, in particular, at least one flavoring compound selected from 3-hydroxy-2-methyl-4H-pyran-4-one, 2-ethyl-3-hydroxy-4H-pyran-4-one, 2,5-dimethyl-4-hydroxy-3(2H)-furanone, 3-methyl-1,2-cyclopentanedione, 3-ethyl-1,2-cyclopentanedione, 3,4-methylenedioxybenzaldehyde, 3-hydroxy-4,5-dimethyl-2(5H)-furanone, 5-ethyl-3-hydroxy-4-methyl-2(5H)-furanone, 2-ethyl-4-hydroxy-5-methyl-3(2H)-furanone, 3,4-dimethyl-1,2-cyclopentanedione and lactones, whereby the agent can impart glutinous and delicate sweetness well resembling “hydrogenated oil flavor” to the food cooked therewith.

These flavoring compounds can be any of those extracted from natural sources or synthesized products. As commercially available compounds, for example, 3-hydroxy-2-methyl-4H-pyran-4-one (Sigma-Aldrich Corp.), 2-ethyl-3-hydroxy-4H-pyran-4-one (Penta Manufacturing Co.), 2,5-dimethyl-4-hydroxy-3(2H)-furanone (Firmenich Inc.), 3-methyl-1,2-cyclopentanedione (Soda Aromatic Co., Ltd.), 3-ethyl-1,2-cyclopentanedione (Sigma-Aldrich Corp.), 3,4-methylenedioxybenzaldehyde (Berje Inc.), 3-hydroxy-4,5-dimethyl-2(5H)-furanone (Soda Aromatic Co., Ltd.), 5-ethyl-3-hydroxy-4-methyl-2(5H)-furanone (Givaudan Corp.), 2-ethyl-4-hydroxy-5-methyl-3(2H)-furanone (Givaudan Corp.), 3,4-dimethyl-1,2-cyclopentanedione (Givaudan Corp.) and the like can be named, but are not limited thereto.

As the lactones, generally those of carbon numbers within a range of 8-12, for example, δ-octalactone, δ-nonalactone, δ-decalactone, δ-undecalactone, δ-dodecalactone, γ-octalactone, γ-nonalactone, γ-decalactone, γ-undecalactone, γ-dodecalactone and the like can be named, but the lactones are not limited thereto.

The hydrogenated oil flavor-imparting agent of the present invention can contain the above flavoring compound at a concentration within a range of generally 0.001-50 wt %, preferably 0.1-15 wt %, inter alia, 1-5 wt %, based on the weight of the flavor-imparting agent.

The hydrogenated oil flavor-imparting agent of the invention can further contain, where necessary, fatty acid, in particular, at least a fatty acid selected from lauric acid, myristic acid, palmitic acid, stearic acid, oleic acid, linoleic acid and linolenic acid, whereby imparting to food the glutinous delicate sweetness very closely resembling “hydrogenated oil flavor”. These fatty acids may be either extracts from natural sources or synthesized products.

The hydrogenated oil flavor-imparting agent of the present invention can contain such fatty acid at a concentration within a range of generally 0.1-95 wt %, preferably 1-60 wt %, inter alia 5-30 wt %, based on the weight of the flavor-imparting agent.

Furthermore, the hydrogenated oil flavor-imparting agent of the invention can be suitably blended with a solvent component such as MCT, glycerin and the like, for example; and oil soluble component for food, such as flavor, spice extract and the like.

The above-described hydrogenated oil flavor-imparting agent of the invention can be directly added to food, for example, doughnuts, bread or their premixes; and confectionery such as cakes, pies, chocolate and the like, to impart to the food “hydrogenated oil flavor” upon subsequent heat treatment. Also it can be added to oils and fats to make them hydrogenated-oil-flavored oils and fats of the invention.

Starting oils and fats useful for formulating hydrogenated-oil-flavored oils and fats by addition of the hydrogenated oil flavor-imparting agent of the invention include, for example, optional edible oils and fats such as soybean oil, rapeseed oil, safflower (Carthamus tinctorius L.) oil, corn oil, sunflower oil, cotton seed oil, rice oil, olive oil, palm oil, coconut oil, sesame oil, beef tallow, lard, fish oil, hydrogenated oil, medium chain fatty acid triglyceride (hereafter abbreviated as MCT) and the like, or processed oils and fats formed by subjecting those oils and fats to such treatment as fractionation, hydrogenation, ester interchange or the like. These starting oils and fats can be used each alone or in combination of two or more. The starting oils and fats themselves are desirably those which have been highly purified to be entirely flavor-free or nearly flavor-free.

The hydrogenated oil flavor-imparting agent of the present invention can be added to a starting oils and fats, in such an amount that the resultant hydrogenated-oil-flavored oil and fat comes to contain vanillin and/or ethyl vanillin at a concentration within a range of generally 1-10,000 ppm, preferably 50-2,000 ppm, inter alia, 100-400 ppm, based on the weight of the hydrogenated-oil-flavored oil and fat.

The hydrogenated-oil-flavored oils and fats of the invention can also contain, where necessary, above-described flavoring compound at a concentration within a range of generally 0.01-5,000 ppm, preferably 10-500 ppm, inter alia, 25-100 ppm, based on the weight of the hydrogenated-oil-flavored oil and fat; and furthermore can contain, where necessary, above-described fatty acid at a concentration within a range of generally 1-12,000 ppm, preferably 50-2,500 ppm, inter alia, 125-450 ppm, based on the weight of the hydrogenated-oil-flavored oil and fat.

A working embodiment of the hydrogenated-oil-flavored oils and fats according to the invention is given in the following, by way of an example: a mixture of vanillin, 3-hydroxy-2-methyl-4H-pyran-4-one, stearic acid and MCT is stirred at 40° C. and dissolved to provide a hydrogenated oil flavor-imparting agent, a minor amount of which is added to palm oil and dissolved to make it a hydrogenated-oil-flavored oil and fat. Again if desired, spice or flavor, or antioxidant such as vitamin E can be added. The resulting hydrogenated-oil-flavored oils and fats may also be changed their form to emulsion, powder or the like if desired, by any suitable means. Where so obtained hydrogenated-oil-flavored oil and fat is used as frying oil, it can be used repeatedly several times, stably and economically imparting hydrogenated oil flavor to the fried food during the use.

Furthermore, hydrogenated oil can be partially blended into the starting oils and fats in the occasion of formulating the hydrogenated-oil-flavored oils and fats of the present invention, whereby achieving such effects as imparting to the hydrogenated-oil-flavored oils and fats not only “hydrogenated oil flavor” as a flavor, but also the “hydrogenated oil flavor” as a taste or body (relish), and imparting to oils and fats or food sufficient “hydrogenated oil flavor” even when the content(s) of vanillin and/or ethyl vanillin, or of the above-described flavoring compound and/or fatty acid which are added as necessity arises, are reduced.

The amount of the hydrogenated oil to be blended with the starting oils and fats varies depending on the kind of the starting oils and fats or of the hydrogenated oil to be added, while normally adequate range is 1-20 wt parts, preferably 1-10 wt parts, inter alia, 1-5 wt parts, per 100 wt parts of the starting oils and fats.

Such hydrogenated-oil-flavored oil and fat formed of a starting oil and fat partially blended with hydrogenated oil can contain vanillin and/or ethyl vanillin at a concentration within a range of normally 8-80 ppm, in particular, 24-60 ppm, based on the weight of the hydrogenated-oil-flavored oil and fat.

The hydrogenated-oil-flavored oil and fat formed of a starting oil and fat partially blended with hydrogenated oil can also contain, where necessary, above-described flavoring compound at a concentration within a range of normally 2-20 ppm, in particular, 5-15 ppm, based on the weight of the hydrogenated-oil-flavored oil and fat, and furthermore, where necessary, above-described fatty acid at a concentration within a range of normally 5-50 ppm, in particular, 10-40 ppm, based on the weight of the hydrogenated-oil-flavored oil and fat.

The starting oils and fats which are used for the hydrogenated-oil-flavored oils and fats of the present invention preferably consist essentially of 1-20 wt %, in particular, 2-10 wt %, of hydrogenated oil and 80-99 wt %, in particular, 90-98 wt %, of unhydrogenated oil, whereby the “hydrogenated oil odor” generated during their use in cooking with heat is decreased, and even when their trans fatty acid content is reduced, still the “hydrogenated oil flavor” meaning the favorable flavor and relish can be imparted to the oils and fats. When the hydrogenated oil content in the hydrogenated-oil-flavored oil and fat is too high, unpleasant “hydrogenated oil odor” is sensed when the oils and fats is used for heat cooking, and when the content is too little, favorable “hydrogenated oil flavor” cannot be sufficiently imparted.

As the hydrogenated oil, for example, those obtained by using vegetable oils and fats such as soybean oil, rapeseed oil, palm oil, coconut oil, palm kernel oil and the like, or animal oils and fats such as fish oil, beef tallow, lard and the like, as the starting material and hydrogenating them at temperatures ranging from about 120 to about 200° C. in the presence of nickel catalyst, can be named. The starting material of hydrogenated oil is preferably a liquid oil, for obtaining favorable “hydrogenated oil flavor”, examples of which include rapeseed oil, soybean oil, sunflower seed oil, cotton seed oil, peanut oil, rice bran oil, corn oil, safflower oil, kapok oil, sesame oil, evening primrose oil and the like. They can be used each alone or in combination of two or more.

Also as the hydrogenated oil, preferably those having the melting point within a range of 10-40° C., in particular, 20-35° C., are used, which enables to impart to food the “hydrogenated oil flavor” meaning the favorable flavor and relish, when the resultant hydrogenated-oil-flavored oils and fats are used for heat cooking. When a hydrogenated oil having a melting point lower than 10° C. is used, its “hydrogenated oil flavor”-imparting effect during the heat cooking is weakened. Conversely, when a hydrogenated oil having a melting point higher than 40° C. is used, its “hydrogenated oil flavor”-imparting effect is lost and unpleasant “hydrogenated oil odor” may be generated.

It is particularly preferred to use hydrogenated rapeseed oil as the hydrogenated oil in the above. By partially blending hydrogenated rapeseed oil in the hydrogenated-oil-flavored oil and fat, the resulting hydrogenated-oil-flavored oil and fat can impart, when it is used for heat-cooling food, “hydrogenated oil flavor” meaning the favorable flavor and relish to the food which is free of hydrogenated oil odor.

On the other hand, the unhydrogenated oil is subject to no particular limitation, examples of which include optional edible oils such as soybean oil, rapeseed oil, safflower oil, corn oil, sunflower oil, cotton seed oil, rice oil, olive oil, palm oil, coconut oil, sesame oil, beef tallow, lard, fish oil, medium chain fatty acid triglyceride, or processed oils and fats formed by subjecting these oils to such a treatment as fractionation, ester-interchange or the like. These can be used either alone or in combination of two or more.

The oils and fats useful for preparing the hydrogenated-oil-flavored oils and fats are not particularly limited, while it is preferred to select them to make the trans fatty acid content of the hydrogenated-oil-flavored oil and fat not more then 3 wt %. Trans fatty acid is present in the natural world. For example, milk fat contains about 5 wt % of trans fatty acid and intake of that level of trans fatty acid is considered to have only minor detrimental effect on health. Whereas, as aforesaid, hydrogenated-oil-flavored oil and fat to which “hydrogenated oil flavor” is imparted while reducing its content of trans fatty acid, a substance liable to do harm to health, can be obtained according to the present invention.

Trans fatty acid content of oils and fats can be determined following AOCS Official Method Ce 1f-96 (Revised 2002).

Furthermore, the hydrogenated-oil-flavored oil and fat of the present invention preferably contains, as at least a part of the unhydrogenated oil, palm-originated oil and fat. The use of palm-originated oil and fat improves heat stability of the hydrogenated-oil-flavored oil and fat, and enables to impart favorable “hydrogenated oil flavor” based on the plane palm oil flavor. The content of the palm-originated unhydrogenated oil and fat is not strictly limited, but can be varied over a broad range depending on utility of individual hydrogenated-oil-flavored oil and fat, while it is generally preferred to be at least 50 wt %, in particular, at least 60 wt %, inter alia, at least 80 wt %, based on the weight of the hydrogenated-oil-flavored oil and fat.

As the palm-originated oil and fat, for example, palm oil, palm olein and the like can be named. In particular, when hydrogenated-oil-flavored oil and fat in which palm oil is blended is used for heat-cooking doughnuts, stickiness of doughnuts can be suppressed.

The hydrogenated-oil-flavored oil and fat of the present invention can further be blended with, where necessary, such additives as emulsifier, antioxidant, defoamer, coloring agent and the like.

The hydrogenated-oil-flavored oil and fat according to the invention can be used as, for example, frying oil of doughnuts, bread and the like in a processing such as heating, or can be directly blended with doughnuts, bread or their premixes; confectionery such as cakes, pies, chocholate and the like and cooked with heat, to impart favorable “hydrogenated oil flavor” to these foods and/or enhance the flavor of these foods.

### EXAMPLES

Hereinafter the present invention is explained in further details, referring to Examples and Comparative Examples, it being understood that they are for the purpose of illustration only. The invention is in no way limited thereby.

### Example 1

A mixture of 80 g of vanillin (product of ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C., to formulate a hydrogenated oil flavor-imparting agent. The agent was added to palm oil (Fuji Oil Co., Ltd.) in an amount of 0.2% and dissolved to provide a hydrogenated-oil-flavored oil and fat.

Separately, as the starting materials, 40 g of salt-free butter, 40 g of sugar, 200 g of wheat flour (soft flour), a pinch of salt, 2 teaspoonfuls of baking powder, one-half a teaspoonful of baking soda, one egg, 50 cc of milk and a proper quantity of granulated sugar were mixed and kneaded in the accepted manner to prepare doughnut dough.

Using the above hydrogenated-oil-flavored oil and fat as the frying oil, doughnuts were fried at 180° C. (Product 1 of this invention).

### Example 2

A mixture of 80 g of vanillin (Ube Industries, Ltd.), 20 g of 3-hydroxy-2-methyl-4H-pyran-4-one (Sigma-Aldrich Corp.) and 900 g of MCT (The Nisshin Oillio Group, Ltd.) was dissolved under stirring at 40° C. to provide a hydrogenated oil flavor-imparting agent. The agent was added to palm oil (Fuji Oil Co., Ltd.) in an amount of 0.2% and dissolved to provide a hydrogenated-oil-flavored oil and fat. Using the resultant hydrogenated-oil-flavored oil and fat, doughnuts were fried in the manner similar to Example 1 (Product 2 of this invention).

### Example 3

A mixture of 80 g of vanillin (Ube Industries, Ltd.) and 920 g of MCT (The Nisshin Oillio Group, Ltd.) was dissolved under stirring at 40° C. to provide a hydrogenated oil flavor-imparting agent. The agent was added to palm oil (Fuji Oil Co., Ltd.) in an amount of 0.2% and dissolved to provide a hydrogenated-oil-flavored oil and fat. Using the resultant hydrogenated-oil-flavored oil and fat, doughnuts were fried in the manner similar to Example 1 (Product 3 of this invention).

### Example 4

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of 50:50 palm oil (Fuji Oil Co., Ltd.) and sunflower oil (Fuji Oil Co., Ltd.) in an amount of 0.2% and dissolved to provide a hydrogenated-oil-flavored oil and fat. Using the resultant hydrogenated-oil-flavored oil and fat, doughnuts were fried in the manner similar to Example 1 (Product 4 of this invention).

### Comparative Example 1

Doughnuts were fried in the manner similar to Example 1, except that palm oil was used as the frying oil (Comparative product 1).

### Comparative Example 2

Doughnuts were fried in the manner similar to Example 1, except that hydrogenated palm oil was used as the frying oil (Comparative product 2).

### Sensory Evaluation:

On the flavor of the fried doughnuts of Products 1-4 of the present invention and Comparative products 1-2 as obtained in above Examples and Comparative Examples, a sensory evaluation test was conducted by ten well trained panellers. The panellers scored the doughnuts according to the following evaluation standard. The total scores are shown in Table 1. Also overall sensory evaluation was given as all of the panellers' opinions put together. The results are also shown in Table 1.

### Evaluation Standard

| | |
|---|---|
| Glutinous, delicate sweetness equivalent | 3 points |
| to that obtained in case of using | |
| hydrogenated oil for frying is present | |
| Glutinous, delicate sweetness is slightly | 2 points |
| inferior to that obtained in case of using | |
| hydrogenated oil for frying | |
| No glutinous, delicate sweetness is sensed | 1 point |

TABLE 1

| | Total | |
|---|---|---|
| | Score | Sensory Evaluation |
| Product of this | 29 | Glutinous, delicate sweetness was sufficiently |
| invention 1 | | sensed. |
| Product of this | 26 | Glutinous, delicate sweetness was sufficiently |
| invention 2 | | sensed. |
| Product of this | 21 | Glutinous sweetness was sensed but slightly |
| invention 3 | | lacked balance. |
| Product of this | 21 | Glutinous sweetness was sensed but slightly |
| invention 4 | | lacked balance. |
| Comparative | 10 | Glutinous sweetness was absent, and the |
| product 1 | | flavor derived from the vegetable oil was |
| | | sensed. |
| Comparative | (30) | Glutinous, delicate sweetness was present, |
| product 2 | | while unpleasant hydrogenated oil odor |
| | | also was sensed. |

As shown in Table 1, when palm oil was used as the frying oil, the flavor derived from the vegetable oil was present but no sweetness was sensed (Comparative product 1). When the hydrogenated oil was used as the frying oil, on the other hand, the glutinous sweetness, i.e., “hydrogenated oil flavor”, was present but the unpleasant hydrogenation odor also was sensed (Comparative product 2). By contrast, Products 1-4 of this invention for which hydrogenated-oil-flavored oil and fat were used as the frying oil were free of the unpleasant hydrogenated oil odor, while giving glutinous sweetness, i.e., hydrogenated oil flavor. Thus, favorable flavor and relish were obtained.

### Example 5

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and rapeseed oil (melting point: 35° C.) at a ratio of 90:10, in an amount of 0.05% and dissolved to provide a hydrogenated-oil-flavored oil and fat (trans fatty acid content: 4.4 wt %). Using the resultant hydrogenated-oil-flavored oil and fat, doughnuts were fried similarly to Example 1 (Product 5 of this invention).

### Example 6

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of soybean oil (Fuji Oil Co., Ltd.) and hydrogenated rapeseed oil (melting point: 35° C.) at a ratio of 98:2, in an amount of 0.05% and dissolved to provide a hydrogenated-oil-flavored oil and fat (trans fatty acid content: 1.9 wt %). Using the resultant hydrogenated-oil-flavored oil and fat, doughnuts were fried similarly to Example 1 (Product 6 of this invention).

### Example 7

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of soybean oil, palm oil and hydrogenated rapeseed oil (melting point: 35° C.) at the ratios of 20:78:2, in an amount of 0.05% and dissolved to provide a hydrogenated-oil-flavored oil and fat (trans fatty acid content: 1.5 wt %) Using the resultant hydrogenated-oil-flavored oil and fat, doughnuts were fried similarly to Example 1 (Product 7 of this invention).

### Example 8

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated cotton seed oil at a ratio of 97:3 in an amount of 0.05% and dissolved to provide a hydrogenated-oil-flavored oil and fat (trans fatty acid content: 1.6 wt %). Using the resultant hydrogenated-oil-flavored oil and fat, doughnuts were fried similarly to Example 1 (Product 8 of this invention).

### Example 9

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated soybean oil (melting point: 35° C.) at a ratio of 98:2 in an amount of 0.05% and dissolved to provide a hydrogenated-oil-flavored oil and fat (trans fatty acid content: 1.3 wt %). Using the resultant hydrogenated-oil-flavored oil and fat, doughnuts were fried similarly to Example 1 (Product 9 of this invention).

### Example 10

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated rapeseed oil (melting point: 22° C.) at a ratio of 97:3 in an amount of 0.05% and dissolved to provide a hydrogenated-oil-flavored oil and fat (trans fatty acid content: 1.5 wt %). Using the resultant hydrogenated-oil-flavored oil and fat, doughnuts were fried similarly to Example 1 (Product 10 of this invention).

### Example 11

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm olein (Fuji Oil Co., Ltd.) and hydrogenated rapeseed oil (melting point: 35° C.) at a ratio of 98:2 in an amount of 0.05% and dissolved to provide a hydrogenated-oil-flavored oil and fat (trans fatty acid content: 1.3 wt %). Using the resultant hydrogenated-oil-flavored oil and fat, doughnuts were fried similarly to Example 1 (Product 11 of this invention).

### Example 12

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated rapeseed oil (melting point: 35° C.) at a ratio of 98:2 in an amount of 0.05% and dissolved to provide a hydrogenated-oil-flavored oil and fat (trans fatty acid content: 1.4 wt %). Using the resultant hydrogenated-oil-flavored oil and fat, doughnuts were fried similarly to Example 1 (Product 12 of this invention).

### Example 13

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated rapeseed oil (melting point: 35° C.) at a ratio of 95:5 in an amount of 0.05% and dissolved to provide a hydrogenated-oil-flavored oil and fat (trans fatty acid content: 2.6 wt %). Using the resultant hydrogenated-oil-flavored oil and fat, doughnuts were fried similarly to Example 1 (Product 13 of this invention).

### Example 14

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated rapeseed oil (melting point: 10° C.) at a ratio of 95:5 in an amount of 0.05% and dissolved to provide a hydrogenated-oil-flavored oil and fat (trans fatty acid content: 0.7 wt %). Using the resultant hydrogenated-oil-flavored oil and fat, doughnuts were fried similarly to Example 1 (Product 14 of this invention).

### Example 15

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and extremely hydrogenated rapeseed oil (melting point: 61° C.) at a ratio of 97:3, in an amount of 0.05% and dissolved to provide a hydrogenated-oil-flavored oil and fat (trans fatty acid content: 0.7 wt %). Using the resultant hydrogenated-oil-flavored oil and fat, doughnuts were fried similarly to Example 1 (Product 15 of this invention).

### Example 16

A mixture of 80 g of vanillin (Ube Industries, Ltd.), 20 g of 3-hydroxy-2-methyl-4H-pyran-4-one (Sigma-Aldrich Corp.), 50 g of stearic acid (NOF Corporation) and 850 g of MCT (The Nisshin Oillio Group, Ltd.) was dissolved under stirring at 40° C. to provide a hydrogenated oil flavor-imparting agent. The agent was added to an oil and fat blend of palm oil and hydrogenated cotton seed oil (melting point: 35° C.) at a ratio of 70:30, in an amount of 0.05% and dissolved to provide a hydrogenated-oil-flavored oil and fat (trans fatty acid content: 9.5 wt %). Using the resultant hydrogenated-oil-flavored oil and fat, doughnuts were fried similarly to Example 1 (Product 16 of this invention).

### Sensory Evaluation:

On the flavor of the fried doughnuts of Products 5-16 of the present invention as obtained in the above Examples, a sensory evaluation test was conducted by ten well trained panellers. The panellers scored the doughnuts according to the following standard.

### Evaluation Standard

| | |
|---|---|
| Favorable sweetness and body are present | 3 points |
| Sweetness and body present but are | 2 points |
| slightly weak | |
| No sweetness or body sensed | 1 point |

Also the doughnuts' flavor and relish were evaluated according to the following standard.

### Evaluation Standard

| | |
|---|---|
| Very good | ⊙ |
| Good | ◯ |
| Slightly sensed | Δ |
| Not sensed | X |

Furthermore, overall sensory evaluation was given as all of the panellers' opinions put together. These results are collectively shown in Table 2.

TABLE 2

| | Total | | |
|---|---|---|---|
| | score | Relish | Sensory Evaluation |
| Product 5 | 29 | ⊙ | Sweetness and body were sensed, but |
| | | | slightly unpleasant hydrogenated oil |
| | | | odor also was sensed. |
| Product 6 | 22 | ◯ | Sweetness and body were sensed, but |
| | | | slight liquid oil odor was sensed. |
| Product 7 | 24 | ◯ | Sweetness and body were sensed. |
| Product 8 | 22 | ⊙ | ″ |
| Product 9 | 23 | ⊙ | ″ |
| Product 10 | 24 | ⊙ | Well balanced sweetness and body were |
| | | | sensed. |
| Product 11 | 25 | ⊙ | Well balanced sweetness and body were |
| | | | sensed. |
| Product 12 | 25 | ⊙ | Well balanced sweetness and body were |
| | | | sensed. |
| Product 13 | 26 | ⊙ | Well balanced sweetness and body were |
| | | | sensed. |
| Product 14 | 15 | Δ | Sweetness and body were sensed but the |
| | | | flavor was slightly weak. |
| Product 15 | 17 | Δ | Sweetness and body were sensed but |
| | | | unpleasant hydrogenated oil odor also |
| | | | was sensed. |
| Product 16 | 20 | ◯ | Sweetness and body were sensed but |
| | | | unpleasant hydrogenated oil odor also |
| | | | was sensed. |

### INDUSTRIAL UTILITY

By adding the hydrogenated oil flavor-imparting agent or hydrogenated-oil-flavored oil and fat according to the invention to oil and fat and using the resultant hydrogenated-oil-flavored oil and fat as frying oil in heat cooking food; or by adding them directly to food and heat cooking the food, glutinous, delicate sweetness which is called “hydrogenated oil flavor” can be imparted to the food.

1. A hydrogenated oil flavor-imparting agent characterized by comprising vanillin and/or ethyl vanillin as active ingredient.

2. A hydrogenated oil flavor-imparting agent according to claim 1, which contains vanillin and/or ethyl vanillin at a concentration within a range of 0.1-95 wt %.

3. A hydrogenated oil flavor-imparting agent according to claim 1, which further contains at least one kind of flavoring compound selected from 3-hydroxy-2-methyl-4H-pyran-4-one, 2-ethyl-3-hydroxy-4H-pyran-4-one, 2,5-dimethyl-4-hydroxy-3(2H)-furanone, 3-methyl-1,2-cyclopentanedione, 3-ethyl-1,2-cyclopentanedione, 3,4-methylenedioxybenzaldehyde, 3-hydroxy-4,5-dimethyl-2(5H)-furanone, 5-ethyl-3-hydroxy-4-methyl-2(5H)-furanone, 2-ethyl-4-hydroxy-5-methyl-3(2H)-furanone, 3,4-dimethyl-1,2-cyclopentanedione and lactones, at a concentration within a range of 0.001-50 wt %.

4. A hydrogenated oil flavor-imparting agent according to claim 1, which further contains at least one kind of fatty acid selected from lauric acid, myristic acid, palmitic acid, stearic acid, oleic acid, linoleic acid and linolenic acid, at a concentration within a range of 0.1-95 wt %.

5. Hydrogenated-oil-flavored oil and fat characterized by comprising vanillin and/or ethyl vanillin at a concentration within a range of 1-10,000 ppm.

6. Hydrogenated-oil-flavored oil and fat according to claim 5, which further contains at least one kind of flavoring compound selected from 3-hydroxy-2-methyl-4H-pyran-4-one, 2-ethyl-3-hydroxy-4H-pyran-4-one, 2,5-dimethyl-4-hydroxy-3(2H)-furanone, 3-methyl-1,2-cyclopentanedione, 3-ethyl-1,2-cyclopentanedione, 3,4-methylenedioxybenzaldehyde, 3-hydroxy-4,5-dimethyl-2(5H)-furanone, 5-ethyl-3-hydroxy-4-methyl-2(5H)-furanone, 2-ethyl-4-hydroxy-5-methyl-3(2H)-furanone, 3,4-dimethyl-1,2-cyclopentanedione and lactones, at a concentration within a range of 0.01-5,000 ppm.

7. Hydrogenated-oil-flavored oil and fat according to claim 5, which further contains at least one kind of fatty acid selected from lauric acid, myristic acid, palmitic acid, stearic acid, oleic acid, linoleic acid and linolenic acid, at a concentration within a range of 1-12,000 ppm.

8. Hydrogenated-oil-flavored oil and fat according to claim 5, in which the oils and fats is composed of 1-20 wt % of hydrogenated oil having a melting point of 10-40° C. and 80-99 wt % of unhydrogenated oil.

9. Hydrogenated-oil-flavored oil and fat according to claim 8, in which the hydrogenated oil is hydrogenated rapeseed oil.

10. Hydrogenated-oil-flavored oil and fat according to claim 8, of which trans fatty acid content is not more than 3 wt %.

11. Hydrogenated-oil-flavored oil and fat according to claim 8, in which the unhydrogenated oil contains at least 50 wt % of palm-originated oil and fat.

12. Hydrogenated-oil-flavored oil and fat according to claim 11, in which the palm-derived oil and fat is palm oil or palm olein.

13. Hydrogenated-oil-flavored oil and fat according to claim 4, which is frying oil for doughnuts.

14. Doughnuts fried in hydrogenated-oil-flavored oil and fat as defined in claim 4.

15. A hydrogenated oil flavor-imparting agent according to claim 2, which further contains at least one kind of flavoring compound selected from 3-hydroxy-2-methyl-4H-pyran-4-one, 2-ethyl-3-hydroxy-4H-pyran-4-one, 2,5-dimethyl-4-hydroxy-3(2H)-furanone, 3-methyl-1,2-cyclopentanedione, 3-ethyl-1,2-cyclopentanedione, 3,4-methylenedioxybenzaldehyde, 3-hydroxy-4,5-dimethyl-2(5H)-furanone, 5-ethyl-3-hydroxy-4-methyl-2(5H)-furanone, 2-ethyl-4-hydroxy-5-methyl-3(2H)-furanone, 3,4-dimethyl-1,2-cyclopentanedione and lactones, at a concentration within a range of 0.001-50 wt %.

16. A hydrogenated oil flavor-imparting agent according to claim 2, which further contains at least one kind of fatty acid selected from lauric acid, myristic acid, palmitic acid, stearic acid, oleic acid, linoleic acid and linolenic acid, at a concentration within a range of 0.1-95 wt %.

17. A hydrogenated oil flavor-imparting agent according to claim 3, which further contains at least one kind of fatty acid selected from lauric acid, myristic acid, palmitic acid, stearic acid, oleic acid, linoleic acid and linolenic acid, at a concentration within a range of 0.1-95 wt %.

18. Hydrogenated-oil-flavored oil and fat according to claim 6, which further contains at least one kind of fatty acid selected from lauric acid, myristic acid, palmitic acid, stearic acid, oleic acid, linoleic acid and linolenic acid, at a concentration within a range of 1-12,000 ppm.

19. Hydrogenated-oil-flavored oil and fat according to claim 6, in which the oils and fats is composed of 1-20 wt % of hydrogenated oil having a melting point of 10-40° C. and 80-99 wt % of unhydrogenated oil.

20. Hydrogenated-oil-flavored oil and fat according to claim 7, in which the oils and fats is composed of 1-20 wt % of hydrogenated oil having a melting point of 10-40° C. and 80-99 wt % of unhydrogenated oil.

21. Doughnuts fried in hydrogenated-oil-flavored oil and fat as defined in claim 5.

22. Doughnuts fried in hydrogenated-oil-flavored oil and fat as defined in claim 6.

23. Doughnuts fried in hydrogenated-oil-flavored oil and fat as defined in claim 7.

24. Doughnuts fried in hydrogenated-oil-flavored oil and fat as defined in claim 8.

25. Doughnuts fried in hydrogenated-oil-flavored oil and fat as defined in claim 9.

26. Doughnuts fried in hydrogenated-oil-flavored oil and fat as defined in claim 10.

27. Doughnuts fried in hydrogenated-oil-flavored oil and fat as defined in claim 11.

28. Doughnuts fried in hydrogenated-oil-flavored oil and fat as defined in claim 12.
